(19) United States
(12) Patent Application Publication
(10) Pub. No.: US 2020/0317285 A1
(43) Pub. Date: Oct. 8, 2020

(54) MODULAR BIKE ACCESSORY SYSTEM

(71) Applicants: Matthew James Rettick, Peoria, IL (US); Jacqueline Nicole Rettick, Peoria, IL (US)

(72) Inventors: Matthew James Rettick, Peoria, IL (US); Jacqueline Nicole Rettick, Peoria, IL (US)

(21) Appl. No.: 16/835,879

(22) Filed: Mar. 31, 2020

Related U.S. Application Data
(60) Provisional application No. 62/830,587, filed on Apr. 8, 2019.

(51) Int. Cl. B62J 9/20; B62J 11/00; B62J 45/10; H04M 1/04

(52) U.S. Cl. CPC B62J 9/20; H04M 1/04; B62J 45/10; B62J 11/00

(57) ABSTRACT

A modular bike accessory system; the modular bike accessory system includes a modular mounting assembly including a main body having an upper portion and a lower portion and interchangeable attachment members. The main body is configured to secure to a section of frame and the interchangeable attachment member configured to removably fasten to the main body and support at least one item in an accessible location user access. The device is structured to accommodate assorted items including exercise accessories, electronic devices, ear buds, food items, travel tissues, and heart-rate monitors. The accessory system is useful for other exercise devices or stationery exercise devices.

### CROSS-REFERENCE TO RELATED APPLICATION(S)

The present application is related to and claims priority to U.S. Provisional Patent Application No. 62/830,587 filed Apr. 8, 2019, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### Technical Field

The present invention relates generally to the field of holders and mounting devices of existing art and, more specifically, relates to a holder adapted to clamp onto or otherwise attach to a tubular element.

### Related Art

Many people need their phones or other mobile devices for entertainment while exercising. Not all machines, however, have places to secure their devices, leaving people to balance their electronics precariously on handlebars, a display screen, or anywhere there's an available spot. Unfortunately, with even the slight push or movement, devices can fall to the ground, not only causing damage to the device but also potentially the equipment. Some people may even injure themselves while trying to catch their falling device. Other people may skip their work out altogether if they don't have access to electronics. A suitable solution is desired.

U.S. Pat. No. 9,840,264 to Chad R. Johnson relates to a portable electronic device holder for a shopping cart. The described portable electronic device holder for a shopping cart includes a caddy which is adapted to clamp to a cylindrical shopping cart handle. Affixed to an upper portion of the clamp is an enclosure composed of a durable, transparent material configured to comprise two (2) planar panels with an intervening space. Openings at either side of the enclosure permit the insertion of appropriately sized pieces of paper, or paper stock, bearing certain indicia. Attached at an upper surface of the enclosure is a turntable adapted to accommodate a pedestal suitable for the placement of a portable electronic device, such as a mobile telephone. The pedestal is further provided with additional, adjustable brackets capable of restraining mobile electronic devices of assorted sizes.

### SUMMARY OF THE INVENTION

In view of the foregoing disadvantages inherent in the known holders and mounting devices art, the present disclosure provides a novel modular bike accessory system. The general purpose of the present disclosure, which will be described subsequently in greater detail, is to provide a modular bike accessory system.

A modular bike accessory system is disclosed herein. The modular bike accessory system includes a modular mounting assembly comprising a main body having an upper portion and a lower portion. The main body is configured to secure to a section of frame. The upper portion and the lower portion mate and form a main body clamp. The modular mounting assembly further includes an interchangeable attachment member configured to removably fasten to the main body and support at least one item upon the section of frame in a user-accessible location. The interchangeable attachment member comprises a cradle for receiving and supporting the electronic device, including a cellphone. The modular bike accessory system allows people to safely use a mobile device while riding a stationary bike or using other exercise equipment. Additionally, the interchangeable attachment members may resemble a cradle or holder for mobile devices. They can be offered in a wide range of styles and designs to accommodate assorted electronics, including smartphones and tablets, in both horizontal and vertical positions.

A method of using the modular bike accessory system is also disclosed herein. The method includes the steps of providing a modular bike accessory system including a modular mounting assembly having a main body having an upper portion and a lower portion and an interchangeable attachment member; securing the modular mounting assembly to a host-item via mating the upper portion and the lower portion of the main body and applying fasteners; attaching the interchangeable attachment member to the main body; securing at least one item to the interchangeable attachment member, and optionally removing the modular mounting assembly.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a modular bike accessory system, constructed and operative according to the teachings of the present disclosure.

FIG. 1 is a perspective view of the modular bike accessory system during an ‘in-use’ condition, according to an embodiment of the disclosure.

FIG. 2 is a perspective view of the modular bike accessory system of FIG. 1, according to an embodiment of the present disclosure.

FIG. 3 is a perspective view of the modular bike accessory system of FIG. 1, according to an embodiment of the present disclosure.

FIG. 4 is a perspective view of the modular bike accessory system of FIG. 1, according to an embodiment of the present disclosure.

FIG. 5 is a flow diagram illustrating a method of using a modular bike accessory system, according to an embodiment of the present disclosure.

The various embodiments of the present invention will from now on be described in conjunction with the appended drawings, wherein like designations denote like elements.

### DETAILED DESCRIPTION

As discussed above, embodiments of the present disclosure relate to holders and mounting devices and, more particularly, to a modular bike accessory system as used to improve the mounting of items upon a host-item including exercise accessories, mobile devices, and other electronic devices.

Generally, the modular bike accessory system provides a safe and convenient way to watch videos, listen to music, and view in-coming calls and messages on a mobile device while using a stationary bike which can be clamped onto other exercise equipment as well. Effectively, the system alleviates the hassle of balancing a device on the handlebars or display of a stationary bike, prevents devices from getting bumped or knocked and crashing to the floor, and keeps people entertained while working out to quickly pass the time. In some embodiments, the system holds a mobile device such as a phone. In other embodiments, the device holds a wide range of devices and objects. These objects could include tablets, earbuds, energy bars, travel tissues, heart-rate monitors, and any other accessories that may be used during a workout.

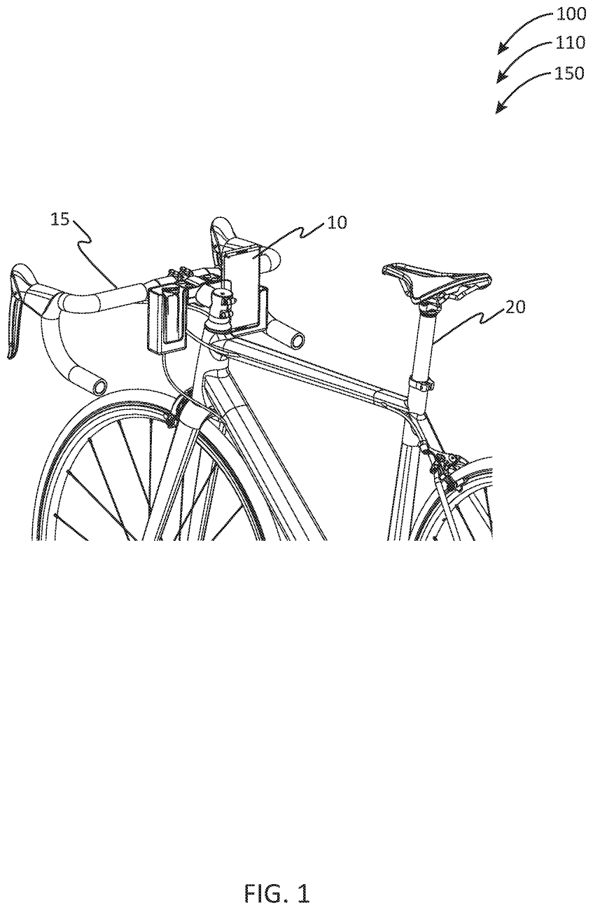

Referring now more specifically to the drawings by numerals of reference, there is shown in FIGS. 1-4, various views of a modular bike accessory system 100.

FIG. 1 shows a modular bike accessory system 100 during an ‘in-use’ condition 150, according to an embodiment of the present disclosure. Here, the modular bike accessory system 100 may be beneficial for use by a user to mount assorted items 10, including cellphones to a stationary bike or other exercise equipment 20. As illustrated, the modular bike accessory system 100 may include a modular mounting assembly 110, including a main body 120 having an upper portion 122 and a lower portion 124. The main body 120 is rigid and configured to secure to a section of frame 15. Tubular or other profiles for frame 15 are used depending on the embodiment. The modular mounting assembly 110 further includes at least one interchangeable attachment member 130 configured to removably fasten to the main body 120 and support at least one item 10 in a user-accessible location. The upper portion 122 and the lower portion 124 mate and form a clamp on the main body 120.

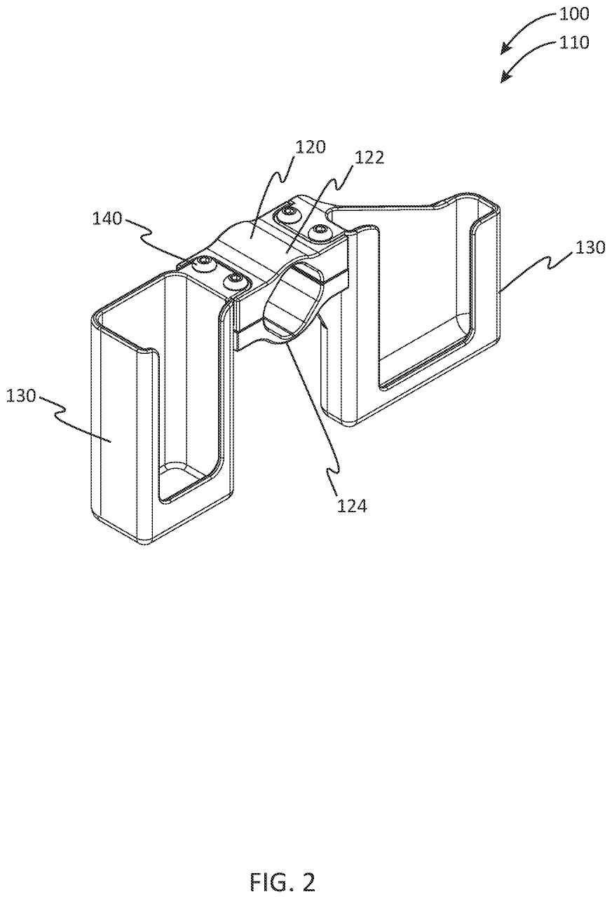

FIG. 2 shows the modular bike accessory system 100 of FIG. 1, according to an embodiment of the present disclosure. As above, the modular bike accessory system 100 may include the modular mounting assembly 110, including at least one interchangeable attachment member 130 and the main body 120 defined by the upper portion 122 and the lower portion 124. The main body 120 is also configured to support more than one interchangeable attachment member 130. In some embodiments, these interchangeable attachment members 130 mount on opposing sides of the main body 120. The upper portion 122 and the lower portion 124 are removably secured together around the section of frame 15 of a piece of exercise equipment 20, including part of a bicycle frame (handlebars) via a plurality of fasteners 140. The plurality of fasteners 140 includes nuts and bolts or other suitable fastening means. The upper portion 122 or the lower portion 124 comprises a semi-arcuate profile and form a circular clamp on the main body 120. This clamp is useful to attach to the section of frame 15. The device provides a portable means for mounting assorted items 10.

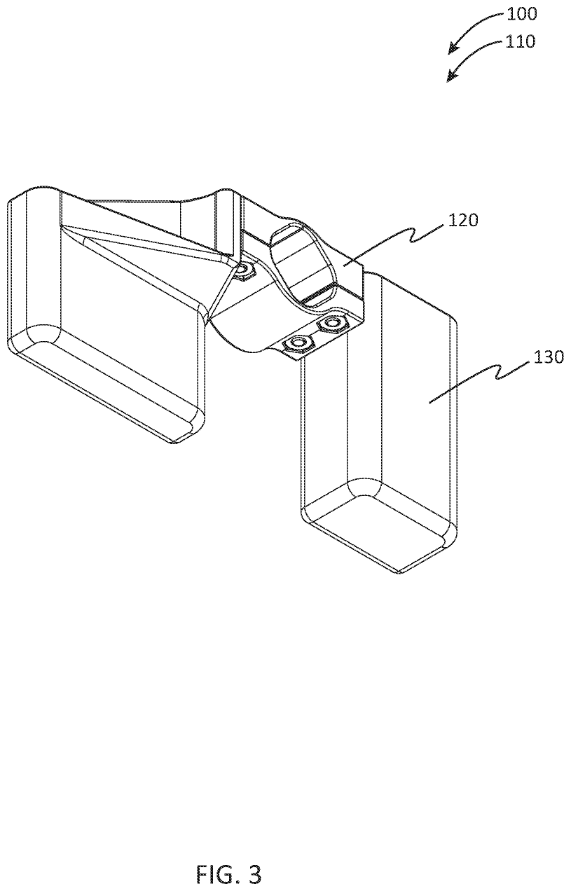

FIG. 3 is a perspective view of the modular bike accessory system 100 of FIG. 1, according to an embodiment of the present disclosure. The modular mounting assembly 110 includes the main body 120 and at least one interchangeable attachment member 130. The interchangeable attachment member 130 may be removably fastened to the main body 120 via mechanical fastening, via tabs and slots, or via a press-fit connection. The interchangeable attachment member 130 may be provided in a plurality of variations for supporting a variety of items 10, including exercise accessories, electronic devices, earbuds, food items, travel tissues, and heart-rate monitors. The items 10 may be supported in a horizontal position or a vertical position. In a preferred embodiment, the interchangeable attachment member 130 is adapted for supporting an electronic device such as a cellphone or tablet. In this embodiment, the interchangeable attachment member 130 comprises a cradle for receiving and supporting the electronic device. The interchangeable attachment member 130 supports the electronic device in a position allowing a user to easily view a screen of the electronic device.

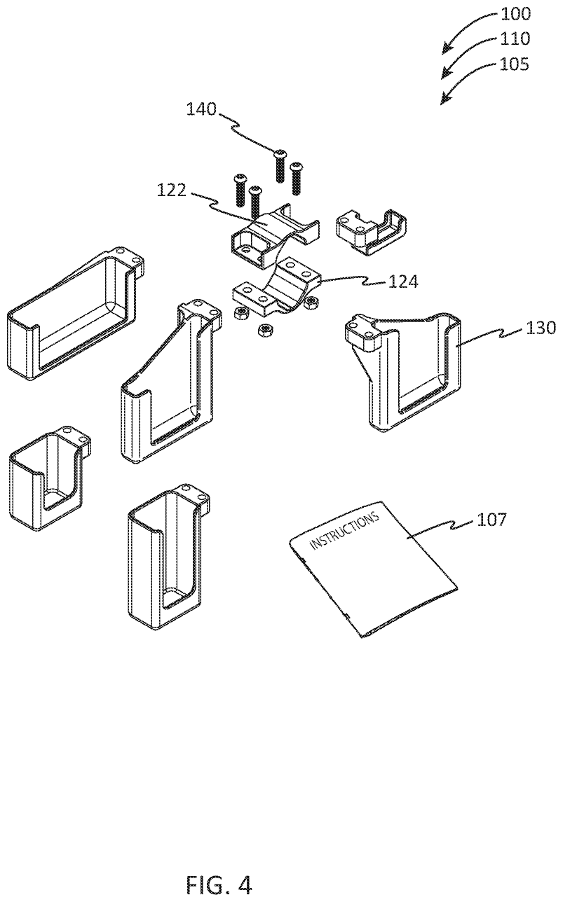

As shown in FIG. 4, according to one embodiment, the modular bike accessory system 100 may be arranged as a kit 105. In particular, the modular bike accessory system 100 may further include a set of instructions 107. The instructions 107 may detail functional relationships in relation to the structure of the modular bike accessory system 100 such that the modular bike accessory system 100 can be used, maintained, or the like, in a preferred manner.

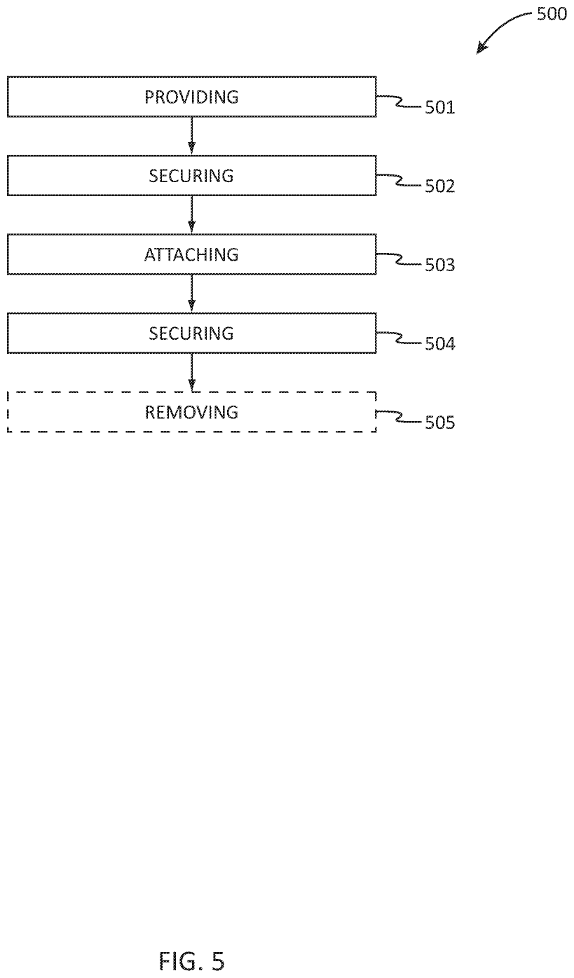

FIG. 5 is a flow diagram illustrating a method of using a modular bike accessory system, according to an embodiment of the present disclosure. In particular, the method of using a modular bike accessory system 500 may include one or more components or features of the modular bike accessory system 100, as described above. As illustrated, the method of using a modular bike accessory system 500 may include the steps of step one 501, providing a modular bike accessory system including a modular mounting assembly 110 having a main body 120 having an upper portion 122 and a lower portion 124 and an interchangeable attachment member 130; step two 502, securing the modular mounting assembly 110 to a host-item via mating the upper portion 122 and the lower portion 124 of the main body 120 and applying fasteners; step three 503, attaching the interchangeable attachment member 130 to the main body 120; step four 504, securing at least one item 10 to the interchangeable attachment member 130; and step five 505, removing the modular mounting assembly 110.

It should be noted that step five 505 is optional and may not be implemented in all cases. Optional steps of method of use 500 are illustrated using dotted lines in FIG. 5 to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods of using a modular bike accessory system, are taught herein.

The embodiments of the invention described herein are exemplary and numerous modifications, variations, and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A modular bike accessory system comprising a modular mounting assembly including
a main body having an upper portion and a lower portion and configured to secure to a section of frame;
an interchangeable attachment member configured to fasten to the main body and support an item in a user-accessible location;
and
wherein the upper portion and the lower portion mate and form a clamp.

2. The modular bike accessory system of claim 1, wherein a plurality of fasteners connects the upper portion and the lower portion.

3. The modular bike accessory system of claim 2, wherein the plurality of fasteners includes nuts and bolts.

4. The modular bike accessory system of claim 1, wherein the interchangeable attachment member is removably fastened to the main body.

5. The modular bike accessory system of claim 1, wherein tabs and slots are used to removably fastened the interchangeable attachment member to the main body.

6. The modular bike accessory system of claim 1, wherein a press-fit connection removably attaches the interchangeable attachment member to the main body.

7. The modular bike accessory system of claim 1, wherein the item is selected from any one of exercise accessories, electronic devices, ear buds, food items, travel tissues, and heart-rate monitors.

8. The modular bike accessory system of claim 7, wherein the item is supported in a horizontal position.

9. The modular bike accessory system of claim 7, wherein the item is supported in a vertical position.

10. The modular bike accessory system of claim 7, wherein the interchangeable attachment member comprises a cradle for receiving and supporting the item.

11. The modular bike accessory system of claim 1, wherein the section of frame is part of exercise equipment.

12. The modular bike accessory system of claim 11, wherein the section of frame is part of a bicycle handlebar.

13. The modular bike accessory system of claim 1, wherein the upper portion or the lower portion comprises a semi-arcuate profile and form a circular clamp.

14. The modular bike accessory system of claim 1, wherein the main body supports two of the same or different interchangeable attachment members.

15. The modular bike accessory system of claim 1, wherein the modular mounting assembly is rigid.

16. The modular bike accessory system of claim 1, wherein the modular mounting assembly is portable.

17. A modular bike accessory system comprising a modular mounting assembly including:
a main body having an upper portion and a lower portion and configured to secure to a section of frame;
an interchangeable attachment member configured to fasten to the main body and support an item in a user-accessible location;
and
wherein the upper portion and the lower portion mate and form a clamp;
wherein nuts and bolts connect the upper portion and the lower portion;
wherein the upper portion or the lower portion comprises a semi-arcuate profile and form a circular clamp;
wherein the item is selected from any of exercise accessories, electronic devices, ear buds, food items, travel tissues, and heart-rate monitors;
wherein the interchangeable attachment member comprises a cradle for receiving and supporting a cellphone;
wherein the section of frame is part of exercise equipment;
wherein the main body supports two of the same or different interchangeable attachment members;
wherein the modular mounting assembly is rigid; and
wherein the modular mounting assembly is portable.

18. The modular bike accessory system of claim 17, further comprising a set of instructions; and wherein the modular bike accessory system is arranged as a kit.

19. A method of using a modular bike accessory system comprising the steps of:
providing the modular bike accessory system of claim 1;
securing the modular mounting assembly to a host-item by mating the upper portion and the lower portion and applying fasteners;
attaching the interchangeable attachment member to the main body;
and
securing at least one item to the interchangeable attachment member.

20. The method of claim 19, further comprising the step of removing the modular mounting assembly.
